(19) United States
(12) Patent Application Publication
(10) Pub. No.: US 2014/0053682 A1
(43) Pub. Date: Feb. 27, 2014

(54) PLATE FOR PROTECTING PORTABLE POWER EQUIPMENT

(71) Applicant: Thomas Bendien, Leesburg, VA (US)

(72) Inventor: Thomas Bendien, Leesburg, VA (US)

(21) Appl. No.: 13/887,063

(22) Filed: May 3, 2013

Related U.S. Application Data
(60) Provisional application No. 61/691,423, filed on Aug. 21, 2012.

(51) Int. Cl. F16P 1/00

(52) U.S. Cl. CPC F16P 1/00
USPC 74/612; 29/525.11

(57) ABSTRACT

A protective plate for power equipment, such as chainsaws. The protective plate may include a front skid plate bend, a side impact bend, a gas tank protection bend, and a rear handle bend to protect different areas of the chainsaw's body from damage. The protective plate may be secured to the bottom of the chainsaws body by using bolts.

### BACKGROUND OF THE INVENTION

The present invention relates to a protection device for power equipment and, more particularly, to a plate device for protecting a chainsaw body.

Portable power equipment, such as chainsaws and cutoff saws used for cutting wood, steel and concrete, may be susceptible to costly damage. For example, the underside and side of the fuel tank, rear handle and crankcase may be damaged due to impact. Penetration by sharp objects, abrasion or heat may cause further damage. Any damage to the equipment may make the equipment unusable or may compromise the safety of the equipment. The resultant repairs needed to the unit may be costly and may take several days or weeks, causing lost productivity. Particularly in settings where the equipment is being used by first responders such as firefighters, police, EMT staff etc, the serviceability of equipment is critical, as it is used on a regular basis to save lives.

As can be seen, there is a need for a protecting vulnerable parts of power equipment to ensure its availability for service and to lengthen the useful lifespan of the power equipment.

### SUMMARY OF THE INVENTION

In one aspect of the present invention, a plate protection device comprises: a base plate having a first side, a second side, a front end, and a back end; a front skid plate bend formed at the front end of the base; and a fastening component configured to secure the base plate to a bottom of a chainsaw body.

These and other features, aspects and advantages of the present invention will become better understood with reference to the following drawings, description and claims.

### BRIEF DESCRIPTION OF THE DRAWINGS

FIG. 1 is a perspective view of the present invention shown in use;

FIG. 2 is an exploded perspective view of the present invention;

FIG. 3 is a top view of the present invention;

FIG. 4 is a right side view of the present invention;

FIG. 5 is a front view of the present invention; and

FIG. 6 is an exploded perspective view of an alternate embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a protective plate for power equipment, such as chainsaws. The protective plate may include a front skid plate bend, a side impact bend, a gas tank protection bend, and a rear handle bend to protect different areas of the chainsaw's body from damage. The protective plate may be secured to the bottom of the chainsaws body by using bolts.

The present invention may provide protection by utilizing a skid plate design which allows the power tool/equipment (also referred to as a “unit”) to move smoothly over any surface it may be placed on, dropped on or slid along. The skid design may protect the unit's soft plastic underside, metal alloy crankcase, and rear handle assembly. The protection may prevent these parts from being compromised, which may cause potential failure of the unit.

In certain embodiments, the skid plate of the present invention may be positioned to absorb potential harmful impacts such as cutting/severing or penetrating forces from various angles. For example, first responder crews test their power tools daily, and typically allow them to rest on concrete pads, while idling. The vibration caused by the engine running causes the unit to hop and move along the concrete pad, resulting in abrasive contact and wear on the underside of the unit. Over a period of time, usually several months, the crankcase and rear handle assembly become weakened as materials are slowly removed and ultimately the equipment may fail or break apart. This could occur in storage, or while the equipment is being used in a life saving operation. The latter case may result in the loss of life.

The front of the skid plate may be larger, longer and substantially different in shape, thereby offering full impact and abrasion protection for the equipment crankcase frontal area and rear section of the fuel tank handle. In addition, the skid plate may include additional material which specifically protects the exposed side area of the fuel tank from abrasion, penetration by sharp or hot objects, impacts or abrasion caused by the unit being dropped or rolled along the ground or other hard surfaces, such as inside vehicle equipment lockers. The plate may be made from metal, a strong plastic, or another material that can absorb impact and/or provide heat resistance to a power tool while also being lightweight.

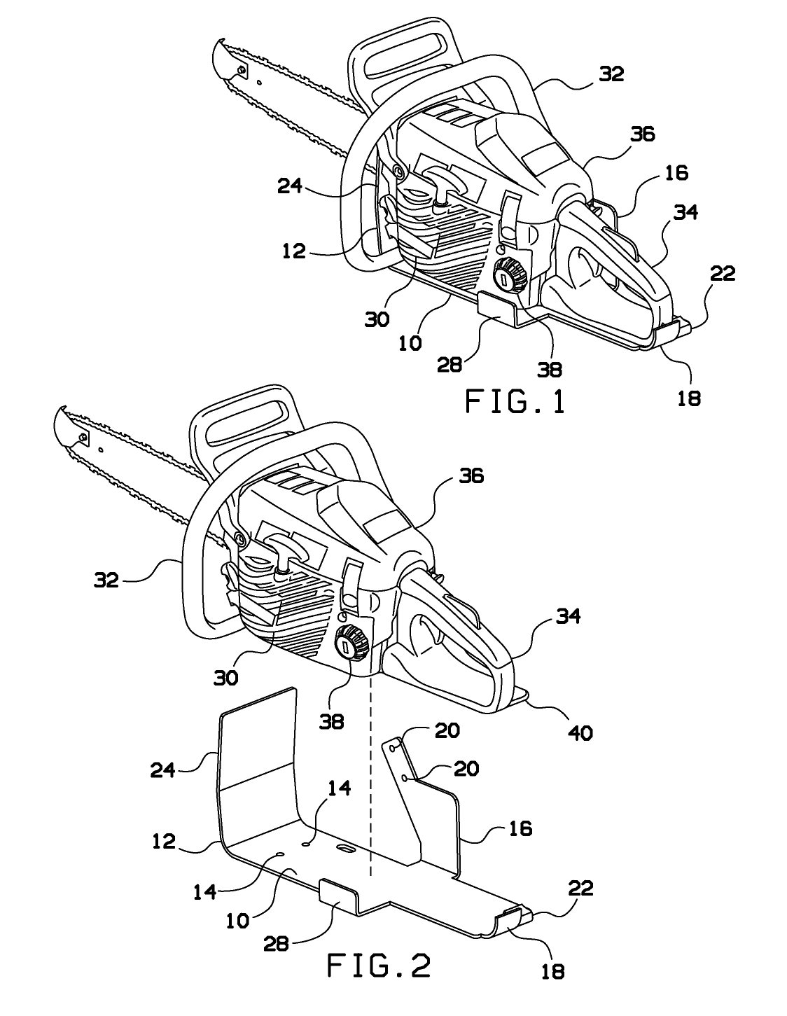

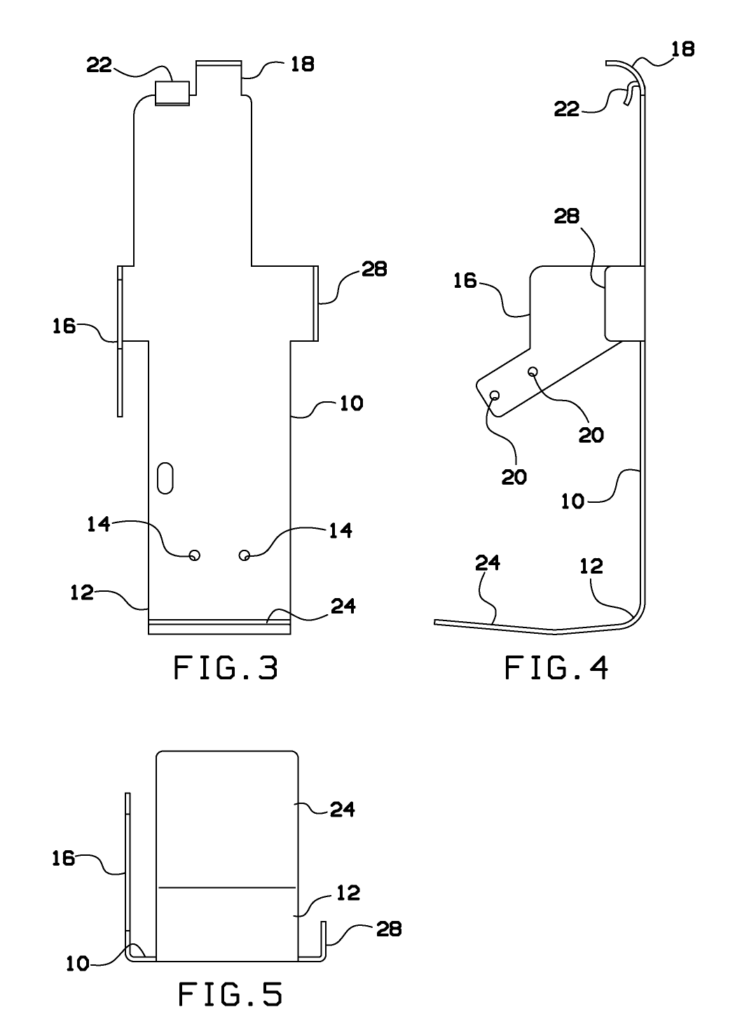

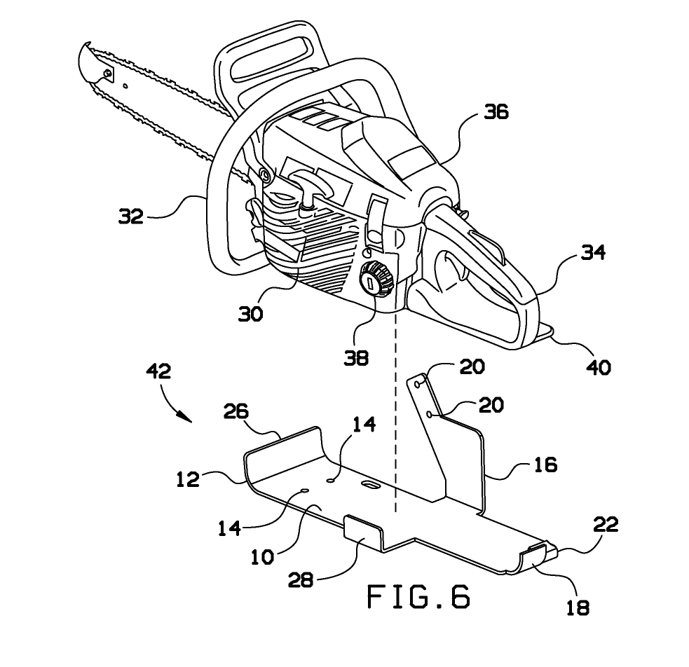

Referring to FIGS. 1 through 6, the present invention may include a base 10. The base 10 may be the skid plate and may be substantially flat. The base 10 may carry the weight of the chainsaw 36 whilst it is placed on the ground, in a vehicle, or other location, so as to absorb any abrasive, tearing, puncture or other damaging effect from the surface upon which it is placed. The base 10 may include a first side, a second side, a front end and a back end.

The base 10 may include a fastening component that may secure the base 10 to the underside of a unit, such as the chainsaw 36. For example, the fastening component may include base fastener openings 14 to allow for screws or bolts to secure the base 10 to the underside of the chainsaw 36. In certain embodiments, the base fastener openings 14 may be aligned with the chainsaw's front handle 32 and thereby the bolts or screws may attach the base 10 to the front handle 32. The base fastener openings 14 may be designed to avoid interfering with the anti vibration features of the chainsaw 36, and may not change the normal function of the chainsaw 36. It is envisioned that any fastening component in the art may be used in any appropriate location to secure the present invention to a unit.

In certain embodiments, the base 10 of the present inventions may include bends for further protection of the chainsaw 36. As illustrated in the Figures, the front side of the base may include a front skid plate bend 12. The front skid plate bend 12 may resemble a ski tip. The front skid plate bend 12 may provide protection for the front lower section of the chainsaw 36, and may allow the unit to slide comfortably over obstacles, should it be dropped, fall or be thrown, intentionally or otherwise. In certain embodiments, the front ski plate bend 12 may form a front portion 26. The front portion 26 may protect the front of the chainsaw. The front portion 26 may be any desired size. For example, as illustrated in FIGS. 1 through 5, the front portion 26 may be an extended front portion 24 to protect a substantial area of the front side of the chainsaw 36.

In certain embodiments, the base 10 may include a side impact bend 16. The side impact bend 16 may be formed on the first side of the base 10. The side impact bend 16 may protrude upward and may run along the side of the chainsaw 36. The side impact bend 16 may also protect at least a portion of a rear handle 34 of the chainsaw 36. In certain embodiments, the side impact bend 16 may be at an angle of about 90 degrees relative to the base 10. In certain embodiments, the side impact bend 16 may further include a second fastening component. As illustrated in FIG. 2, the fastening component may include side impact plate fastener openings 20 to facilitate the side impact bend 16 to be secured to the chainsaw 16 by screws or bolts. However, as mentioned above, the fastening component may be any fastening component known in the art.

In certain embodiments, the base 10 may further include a fuel tank protection bend 28 extending from the second side of the base 10. In certain embodiments, the fuel tank protection bend 28 may be folded up at about a 90 degree angle relative to the base 10. The fuel tank protection bend 28 may cover at least a portion of the fuel tank 38 of the chainsaw 36. Both the fuel tank protection bend 28 and the side impact bend 16 may provide sturdy protection against side impacts or penetrating forces to the fuel tank 38 of the chainsaw 36.

The back end of the base 10 of the present invention may further include at least one bend. For example, as illustrated in the Figures, the back end may include a rear handle bend 18 and a rear handle lip attachment slide 22. The rear handle bend 18 may extend from the base and may cover at least a portion of the rear handle 34 of the chainsaw 36. This may protect the rear handle 34 from damage. The rear handle lip attachment slide 22 may be shaped to slide onto the rear handle molding 40 of the chainsaw 36. In such embodiments, screws or bolts are not required for further fastening. The rear handle lip attachment slide 22 may be attached to the rear handle molding 40 by firmly pressing the lip 22 on the molding, which may secure the rear portion of the base 10 to the chainsaw 36.

The plate of the present invention may be designed for simple installation in the field, with a single screwdriver, commonly available to most users. Installation does not require any special skills and can be completed within a few minutes with simple instructions, which may be provided with the plate.

In certain embodiments, the present invention may further include add-ons and accessories. For example, the skid plate may further include sling mounting points for carrying accessories. The skid plate may further include mounting hardware attachments for fixing the present invention into a truck locker. The present invention may further include a ladder clamp bracket so that a user may easily clamp the saw to a ladder if needed, such as in a fire fighting setting or when being used on a steep peaked roof. The skid plate of the present invention may further include a friction pad on the bottom for steadying the device, such as for steadying the device on a pitched roof during fire fighting operations.

Although the present embodiment of the invention is illustrated installed on a typical chainsaw body 36, the present invention may be modified to fit any similarly configured, but differently shaped piece of power equipment as known by those in the art. It should be understood, of course, that the foregoing relates to exemplary embodiments of the invention and that modifications may be made without departing from the spirit and scope of the invention as set forth in the following claims.

What is claimed is:

1. A plate protection device comprising:
a base plate having a first side, a second side, a front end, and a back end;
a front skid plate bend formed at the front end of the base; and
a fastening component configured to secure the base plate to a bottom of a chainsaw body.

2. The plate protection device of claim 1, wherein the fastening component comprises at least one opening on the base configured to receive a bolt.

3. The plate protective device of claim 2, wherein the at least one opening is oriented to align with a front handle of the chainsaw body.

4. The plate protection device of claim 3, wherein the at least one opening is two openings.

5. The plate protection device of claim 1, wherein the front skid plate bend forms a front portion configured to cover at least a front section of the chainsaw body.

6. The plate protection device of claim 6, wherein the front skid plate portion is an extended front skid plate portion that is configured to cover a substantial portion of the front section of the chainsaw body.

7. The plate protection device of claim 1, further comprising a side impact bend formed on the first side of the base.

8. The plate protection device of claim 8, wherein the side impact bend includes a fastening component configured to secure the side impact bend to the chainsaw body.

9. The plate protective device of claim 1, further comprising a fuel tank protection bend formed on the second side of the base, and configured to cover a portion of a fuel tank of the chainsaw.

10. The plate protective device of claim 1, further comprising a rear handle bend formed on the back side of the base and configured to cover at least a portion of a rear handle of the chainsaw.

11. The plate protective device of claim 1, further comprising a rear hand lip attachment slide configured to clip onto a rear handle of the chainsaw.

12. A method of protecting a chainsaw comprising:
providing a base plate comprising at least one opening and having a first side, a second side, a front end, and a back end; and
aligning the base plate with a bottom of the chainsaw; and
screwing at least one bolt through the at least one opening of the base and into the front handle of the chainsaw.

13. The method of claim 12, wherein the base comprises a front skid plate bend formed at the front of the base, a side impact bend formed on the first side of the base, a fuel tank protection bend formed on the second side of the base, and a rear handle bend formed on the back side of the base

14. The method of claim 13, further comprising the step of placing a body of the chainsaw within the front skid plate bend, the side impact bend, the gas tank protection bend, and the rear handle bend.

15. The method of claim 14, wherein the side impact bend comprises at least one opening.

16. The method of claim 14, wherein the back end of the base further comprises a handle lip attachment slide.

17. The method of claim 16, further comprising the step of clipping the handle lip attachment slide onto a rear handle of the chainsaw.

18. A plate protection device comprising:
a base plate having a first side, a second side, a front end, and a back end;
a side impact bend formed on the first side of the base, wherein the side impact bend includes a first fastening component configured to secure the side impact bend to the chainsaw body; and
a second fastening component configured to secure the base plate to a bottom of a chainsaw body.

19. The plate protection device of claim 18, wherein the first fastening component and the second fastening component comprises at least one opening configured to receive a bolt.

20. The plate protective device of claim 19, further comprising a front skid plate bend formed at the front end of the base.
